(19) United States
(12) Patent Application Publication
(10) Pub. No.: US 2006/0291496 A1
(43) Pub. Date: Dec. 28, 2006

(54) Routing method in wireless network and communication device using the same

(75) Inventors: Jianliang Zheng, New York, NY (US); Myung-jong Lee, New York, NY (US)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD. CITY UNIVERSITY OF NEW YORK

(21) Appl. No.: 11/431,012

(22) Filed: May 10, 2006

Related U.S. Application Data
(60) Provisional application No. 60/679,225, filed on May 10, 2005.
(60) Provisional application No. 60/680,014, filed on May 12, 2005.

(30) Foreign Application Priority Data
Apr. 17, 2006 (KR) 10-2006-0034538

(51) Int. Cl. H04J 3/26

(52) U.S. Cl. 370/432; 370/335; 370/252; 370/256; 370/403; 370/408

(57) ABSTRACT

A routing method in a wireless network and a communication device using the same is provided. The routing method in the tree-based wireless network includes acquiring an optimal route using a table which is recorded based on received information on neighbor nodes and received information on lower nodes of the neighbor nodes, and transmitting a packet through the optimal route. Accordingly, tree-based mesh routing which performs route discovery block by block is used in order to increase the efficiency of route discovery, and a packet is transmitted through an optimal route so that communication costs can be reduced.

### CROSS-REFERENCE TO RELATED APPLICATIONS

This application claims priority from U.S. Provisional Application Nos. 60/679,225 and 60/680,014, filed May 10, 2005 and May 12, 2005, respectively, in the United States Patents and Trademark Office, and Korean Patent Application No. 10-2006-0034538, filed Apr. 17, 2006 in the Korean Intellectual Property Office, the entire contents of which are incorporated herein by reference.

### BACKGROUND OF THE INVENTION

1. Field of the Invention

Apparatuses and methods consistent with the present invention relate to routing in a wireless network, and more particularly, to efficiently transmitting and receiving data in a wireless network by tree-based mesh routing.

2. Description of the Related Art

Generally, a route discovery in wireless networks, which is used to set a routing path, is performed for one node. Recently, the wireless networks have all the devices in the area cluster-tree structured. Devices joining with the cluster tree structure are allocated with an address according to the tree structure. The allocated address is used for routing in each network environment.

FIG. 1 illustrates a tree structure of a related art wireless network.

In FIG. 1, the related art network includes a parent node A 110 and child nodes B through J, 112 through 142, respectively.

The child node B 112 is associated with the parent node A 110 and the child nodes E 120, F 122 and G 124. The child node C 114 is associated with the parent node A 110 and the child node H 130. The child node D 116 is associated with the parent node A and the child nodes I 140 and J 142. In FIG. 1, each node may be implemented as a device, and each parent node may include table-form address information on the child nodes.

When data is transmitted from the node H 130 to the node F 122 in the wireless network of FIG. 1, the node H 130 is a source node and the node F 122 is a destination node. A data packet transmitted from the node H 130 is transmitted along the only tree structure to the node F 122. The data packet is transmitted necessarily through the parent node thereof, so that it can be transmitted to neighboring nodes along the tree structure.

Accordingly, the data packet transmitted from the node H 130 is sent to node F 122 via the nodes C 114, A 110 and B 112 along the tree structure. In the tree structure of the related art wireless network, the data packet is transmitted along the tree structure from the source node to the destination node, resulting in an inconveniently lengthened routing path and subsequent rise in the communication costs.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

The present invention provides a routing method using tree-based mesh routing in a wireless network to efficiently search for and set a route from a source node to a destination node.

According to an aspect of the present invention, there is provided a routing method in a tree-based wireless network comprising acquiring an optimal route using a table which is recorded based on received information on neighbor nodes and received information on lower nodes of the neighbor nodes, and transmitting a packet through an optimal route.

In acquiring the optimal route, the table may be searched to acquire the optimal route. That is, when an address of a node to receive the packet matches one of beginning addresses recorded in the table, a route through an address of a next hop corresponding to the beginning address recorded in the table is acquired as the optimal route.

Additionally, in acquiring the optimal route, when an address of a node to transmit the packet matches one of the beginning addresses recorded in the table, the route through the address of the next hop corresponding to the beginning address recorded in the table may be acquired as the optimal route.

Acquiring the optimal route may comprise transmitting the acquired optimal route to the node to transmit the packet; and transmitting the packet through the auxiliary route.

The routing method in the tree-based wireless network may further comprise acquiring an auxiliary route using the table recorded based on the received information on the neighbor nodes and the received information on the lower nodes of the neighbor nodes.

Additionally, in acquiring the auxiliary route, when an address of a node to receive the packet does not match one of the beginning addresses recorded in the table, the auxiliary route may be acquired by determining if the address of the node is between an address which is added with “1” to the beginning address recorded in the table, and a last address corresponding to the beginning address.

Additionally, in acquiring the auxiliary route, if the address of the node to receive the packet is between an address which is added with “1” to the beginning address recorded in the table, and the last address corresponding to the beginning address, a route through a node corresponding to the beginning address recorded in the table, and lower nodes of the node corresponding to the beginning address may be acquired as the auxiliary route.

Further, in acquiring the auxiliary route, when the address of the node to transmit the packet does not match one of the beginning addresses recorded in the table, the auxiliary route may be acquired by determining if the address of the node is between an address which is added with “1” to the beginning address recorded in the table, and a last address corresponding to the beginning address.

Additionally, in acquiring the auxiliary route, if the address of the node to receive the packet is between an address which is added with “1” to the beginning address recorded in the table, and the last address corresponding to the beginning address, a route through a node corresponding to the beginning address recorded in the table, and lower nodes of the node corresponding to the beginning address may be acquired as the auxiliary route.

Also, acquiring the auxiliary route may further comprise transmitting the acquired auxiliary route to the node to transmit the packet.

Additionally, acquiring the auxiliary route may further comprise transmitting the acquired auxiliary route to the node to transmit the packet.

Furthermore, in acquiring the optimal route, the table may comprise topology information on the plurality of nodes. The topology information comprises at least one of a beginning address of the node, an ending address of the node, a next hop via which the node can be routed, hops to the beginning address of the node, costs to the beginning address of the node, and time when the node is created or refreshed.

### BRIEF DESCRIPTION OF THE DRAWINGS

The above and other aspects of the present invention will become more apparent by describing in detail exemplary embodiments thereof with reference to the attached drawing figures, wherein;

FIG. 1 illustrates a tree structure of a related art wireless network;

FIG. 2 is a flow chart describing a method of allocating an address in a wireless network according to an exemplary embodiment of the present invention;

FIG. 3 is a chart depicting a route discovery process in the wireless network according to an exemplary embodiment of the present invention;

FIGS. 4A and 4B are views describing an exemplary route request (RREQ) and route replay (RREP) used to set a routing route according to an exemplary embodiment of the present invention;

FIG. 5 is a view describing an exemplary non-tree-table (NTT) written during the route discovery process of FIG. 4;

FIG. 6 is a flow chart describing a method of setting a routing route between a source node and a destination node after route discovery according to an exemplary embodiment of the present invention;

FIG. 7A is a view describing a routing method when a ‘source node’ already knows an optimal route to a ‘destination node’ after route discovery;

FIG. 7B is a view describing a routing method when a ‘destination node’ already knows an optimal route to a ‘source node’ after route discovery; and

FIGS. 8A and 8B are views describing a recovery process when connection between nodes is broken in the wireless network according to an exemplary embodiment of the present invention.

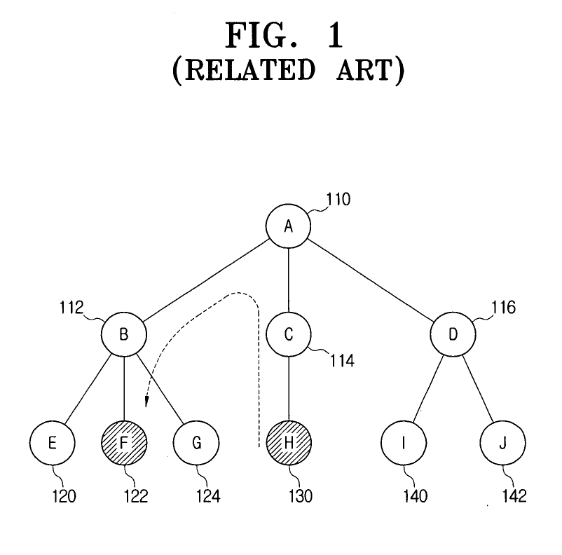

### DETAILED DESCRIPTION OF EXEMPLARY EMBODIMENTS

Hereinafter, exemplary embodiments of the present invention will be described in detail with reference to the accompanying drawings.

In the following description, same drawing reference numerals are used for the same elements even in different drawings. The matters defined in the description, such as detailed construction and element descriptions are provided to assist in a comprehensive understanding of the invention. Also, functions or constructions that are well known to those skilled in the art are not described in detail since they would obscure the invention in unnecessary detail.

In a routing method in the wireless network according to an exemplary embodiment of the present invention, there are an adaptive robust tree (ART) and meshed ART (MART) methods for a tree-based routing method, and also non-tree routing methods. Each of the nodes used for routing communicates bi-directionally.

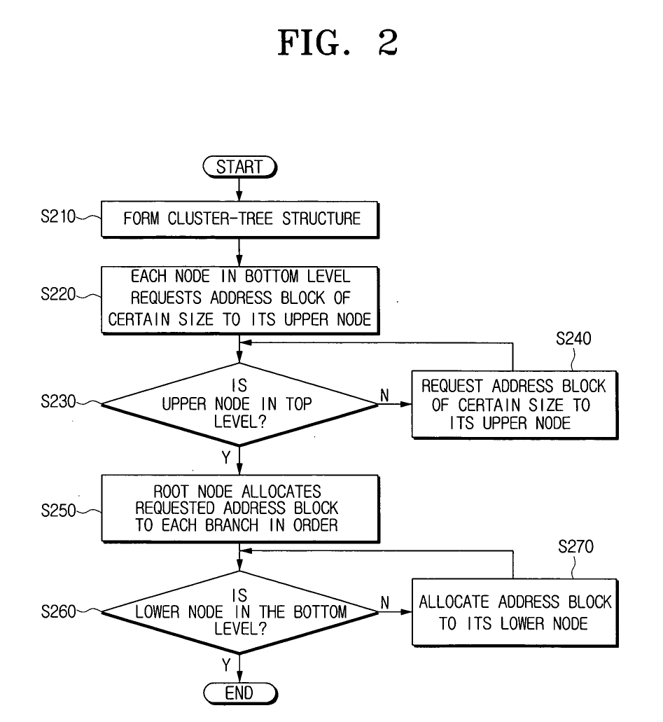

FIG. 2 is a flow chart depicting a method of allocating an address in a wireless network according to an exemplary embodiment of the present invention. Referring to FIG. 2, in the initialization phase, a plurality of nodes are connected to each other to form a cluster-tree structure (S210). More specifically, if node A is a root node start connection, a neighbor node transmits an association request to node A. If node A intends to be connected to the neighbor node, node A replies to the neighbor node. As a result, node A and each node are connected. Each node can be connected to its lower nodes in the same way.

If the cluster-tree structure is formed this way, each node in the bottom level or next upper level bottom-up requests an address block of a certain size to its upper node (S220).

Meanwhile, a node which receives the address block of a certain size determines whether to be in the top level (S230). If the node is not in the top level, the node requests its upper node for an address block of a certain size to use (S240).

The root node allocates address blocks of the requested size to each branch (S250). In this case, the address blocks are sequentially allocated according to the connection order of lower nodes corresponding to each branch.

If each lower node is not in the bottom level (S260), the address block allocated to itself is allocated again to its lower node (S270). In this case, the address blocks of a certain size that its lower nodes requested are sequentially allocated. Accordingly, addresses can be allocated down to each node in the bottom level. Consequently, each node writes an adaptive robust tree table (ARTT) using the address allocated to itself, and performs the routing operation according to the ARTT. The ARTT includes topology information.

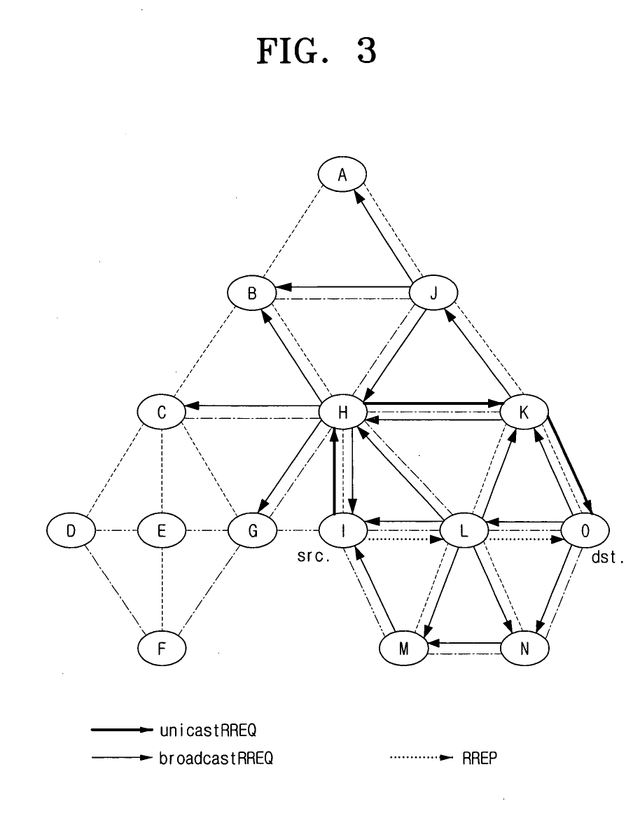

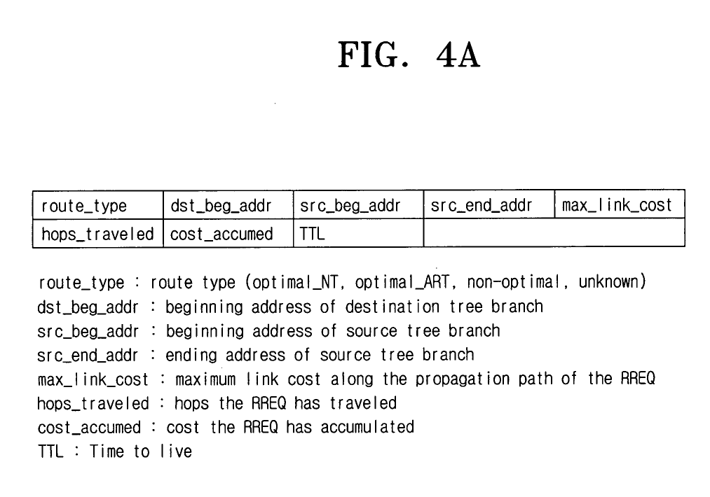

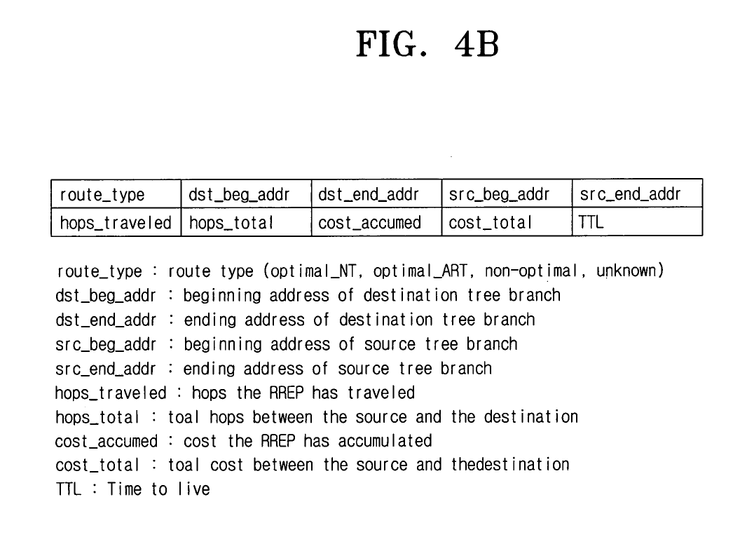

FIG. 3 is a diagram depicting a route discovery process in a wireless network according to another exemplary embodiment of the present invention, and FIGS. 4A and 4B are views describing an exemplary route request (RREQ) and route reply (RREP) used to set a routing route according to an exemplary embodiment of the present invention.

Referring to FIGS. 3-4B, for example, when a packet is transmitted from source node I to destination node O, source node I unicasts an RREQ to destination node O to set a route to destination node O. That is, the routing route of the RREQ is I-H-K-O. The RREQ is a message type used in order for a source node to find a destination node, that is, to request that a route be generated.

As shown in FIG. 4A, the RREQ includes a route_type, dst_beg_addr, src_beg_addr, src_end_addr, max_link_cost, hops_traveled, cost_accumed, and time to live (TTL). A description of each of the fields of the RREQ is also shown in FIG. 4A.

If destination node O receives the RREQ from source node I, destination node O broadcasts the RREQ to find an optimal route to source node I.

Subsequently, source node I receives the RREQ broadcasted from destination node O, so that the optimal route to destination node O can be found. Accordingly, source node I transmits an RREP through the optimal route to destination node O. That is, the optimal route to transmit the RREP from source node I to destination node O becomes I-L-O. In this case, as source node I and destination node O can exchange route information with each other, destination node O can also know the optimal route to source node I.

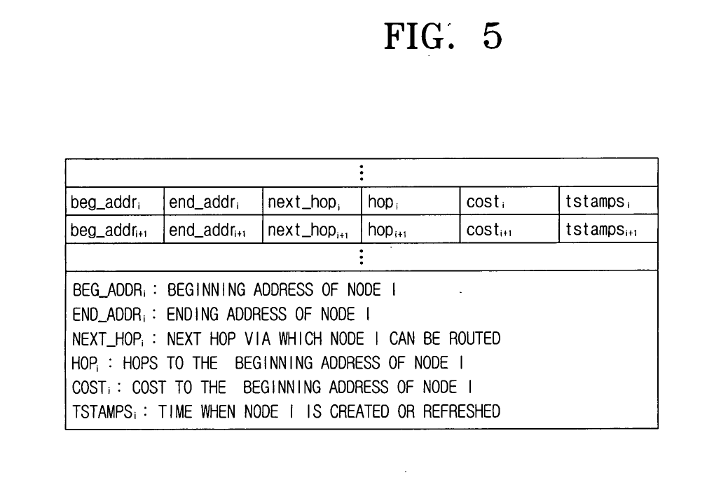

The RREP is a reply to the RREQ. As shown in FIG. 5B, the RREP includes a route_type, dst_beg_addr, dst_end_addr, src_beg_addr, src_end_addr, hops_traveled, hops_total, cost_accumed, total_cost, and TTL. A description of each of the fields of the RREP is shown in FIG. 5B.

Additionally, source node I, which receives the RREQ broadcasted from destination node O, can also find routes to child nodes of destination node O.

For example, the broadcasted RREQ includes information such as the beg_addr and end_addr of destination node O. Accordingly, source node I can find auxiliary routes to child nodes of destination node O. The auxiliary route is a second best route, instead of the optimal route from a source node to a destination node.

FIG. 5 is a view describing an exemplary non-tree-table (NTT) written during the route discovery process of FIG. 3.

Referring to FIG. 5, each node writes the NTT to record the optimal route and auxiliary route between each node through route discovery using the RREQ and RREP, and the NTT is used for performing a routing operation. Each node searches for the optimal route and auxiliary route by referring to the information in its NTT, and performs the routing operation along the searched route. The beg_addrᵢ recorded in the NTT is the optimal route of node I, and the auxiliary routes are from beg_addrᵢ+1 to end_addrᵢ.

FIG. 67 is a flow chart depicting a method of setting a routing route between a source node and a destination node after route discovery according to an exemplary embodiment of the present invention.

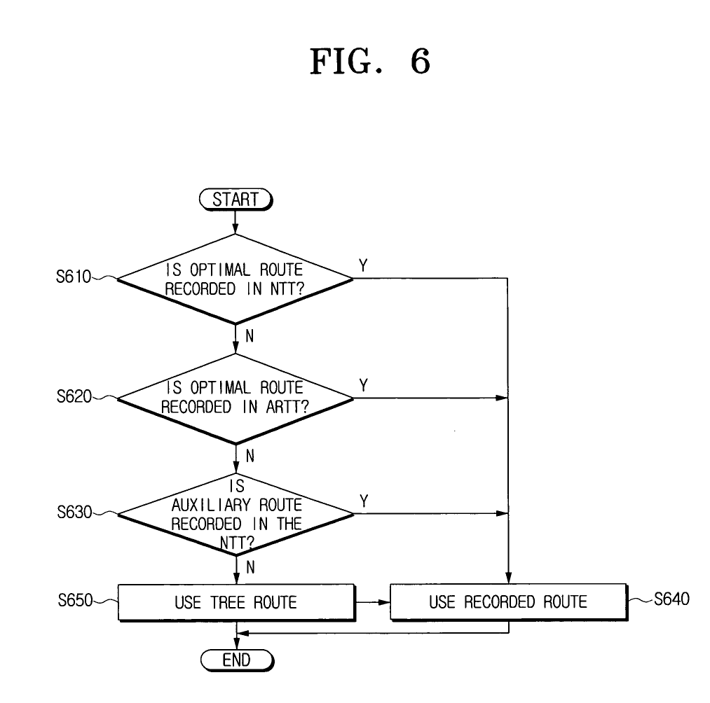

Referring to FIG. 6, first the source node determines if an optimal route to the destination node is recorded in its NTT generated upon route discovery (S610).

That is, the source node determines if the address of the destination node to transmit a packet matches one of a plurality of beg_addr recorded in the NTT of the source node. If the address of the destination node matches one of a plurality of beg_addr recorded in the NTT, the source node determines that an optimal route to the destination node is recorded.

Subsequently, if an optimal route to the destination node is not recorded in the NTT, the source node determines if an optimal route to the destination node is recorded in the ARTT initially generated upon generating a tree (S620). That is, the source node determines if the address of the destination node matches one of a plurality of beg_addr recorded in the ARTT of the source node. If the address of the destination node matches one of a plurality of beg_addr recorded in the ARTT, the source node determines that an optimal route to the destination node is recorded.

If an optimal route to the destination node is not recorded in the ARTT, the source node determines if an auxiliary route to the destination node is recorded in the NTT (S630).

More specifically, if the address of the destination node does not match one of a plurality of beg_addr recorded in the NTT and ARTT of the source node, the source node determines if an auxiliary route to the destination node is recorded in the NTT. That is, the source node determines if the address of the destination node is between beg-addrᵢ+1 recorded in the NTT of the source node and end-addrᵢ. If the address of the destination node is between beg-addrᵢ+1 recorded in the NTT of the source node and end-addrᵢ, the source node determines that an auxiliary route to the destination node is recorded in the NTT.

If an optimal route or auxiliary route to the destination node is determined in operation S610, S620 or S630, the source node transmits the packet through the optimal route or auxiliary route to the destination node (S640).

In detail, if the source node determines that an optimal route to the destination node is recorded in its NTT in the operation of S610, the source node transmits the packet through the optimal route to the destination node. That is, the source node transmits the packet through the address of the next hop corresponding to the beg_addr searched in operation S610 as the optimal route.

However, if the source node determines that an optimal route to the destination node is not recorded in its NTT in operation S610, the source node determines whether an optimal route to the destination node is recorded in the ARTT as in operation S630. If the source node determines that an optimal route to the destination node is recorded in the ARTT, the source node transmits the packet through the optimal route to the destination node.

Meanwhile, if the source node determines that an optimal route to the destination node is not recorded in the ARTT in operation S620, the source node determines whether an auxiliary route to the destination node is recorded in the NTT as in operation S630. If an auxiliary route to the destination node is recorded in the NTT, the source node transmits the packet through the auxiliary route to the destination node.

Next, if the source node determines that neither an optimal nor auxiliary route to the destination node is recorded in the ARTT and NTT, the source node uses a tree route (S650).

For example, when a packet is transmitted from source node I to destination node O, if neither an optimal nor auxiliary route to destination node O is recorded in the NTT and ARTT of source node I, source node I transmits the packet to destination node O using the tree route (ART/MART) generated when the address is initially allocated. That is, the route is I-H-K-I.

In operation S650, if neither an optimal nor auxiliary route to the destination node is recorded in the ARTT and NTT, the source node performs the route discovery again to record an optimal route to the destination node in the NTT.

Meanwhile, in a routing method in the wireless network, the process of operations S610 through S650 used to set an optimal route between the source node and destination node can be performed in the destination node as well as in the source node.

More specifically, when the source node performs operations S610 through S650, if the source node does not transmit a packet through an optimal route, the destination node can transmit the packet through an optimal or auxiliary route to the source node by performing operations S610 through S650.

That is, the destination node determines if an optimal or auxiliary route to the source node is recorded in the NTT and ARTT of the destination node. If an optimal or auxiliary route to the source node is in the tables of the destination node, the packet is transmitted through the searched route to the source node. If an optimal or auxiliary route to the source node is not in the tables of the destination node, the destination node uses either the tree route or the route discovery to transmit the packet from the destination node to the source node, as described in operation S650.

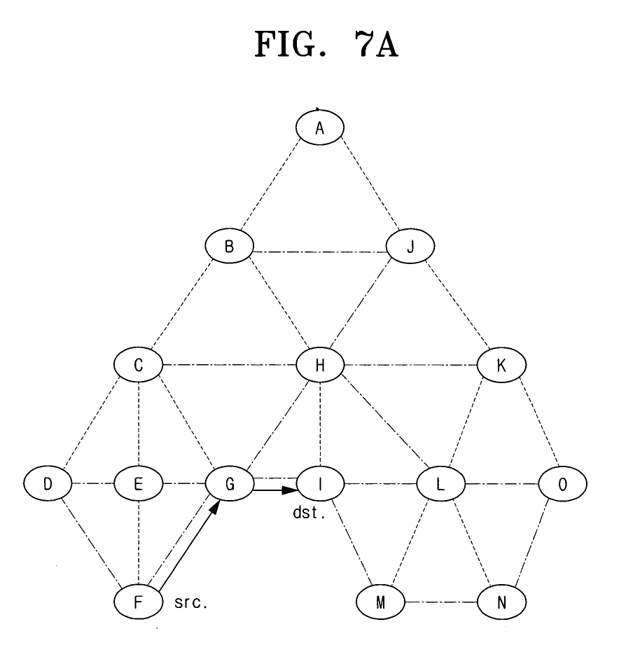

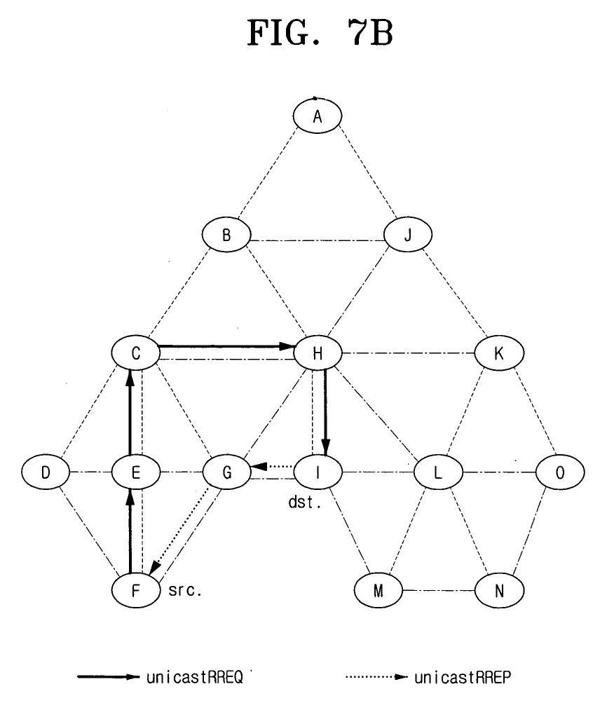

FIGS. 7A and 7B are views depicting a routing method according to an another exemplary embodiment of the present invention. FIG. 7A is a view describing a routing method when a ‘source node’ already knows an optimal route to a ‘destination node’ after route discovery. The case of not knowing an optimal route is that an optimal or auxiliary route to the destination node or the source node is not recorded in the NTT and ARTT.

First, referring to FIG. 7A, for example, when a packet is transmitted from source node F to destination node I, source node F determines if an optimal route to destination node I is recorded in its NTT. As an optimal route to destination node I is already recorded in the NTT of source node F generated upon route discovery, the routing route to transmit the packet from source node F is F-G-I.

More specifically, connection of source node F and destination node I is not tree-based, but source node F can transmit a packet through an optimal route to destination node I using neighbor node G. Node G exchanges information on lower nodes of neighbor nodes F and I with its neighbor nodes F and I. That is, node G provides information on its connection with nodes E and F to node I, and node I provides information on its connection with nodes L and M to node G. Accordingly, source node F can transmit the packet to destination node I along the optimal route F-G-I recorded in the NTT.

FIG. 7B is a view describing a routing method when a ‘destination node’ already knows an optimal route to a ‘source node’ after route discovery.

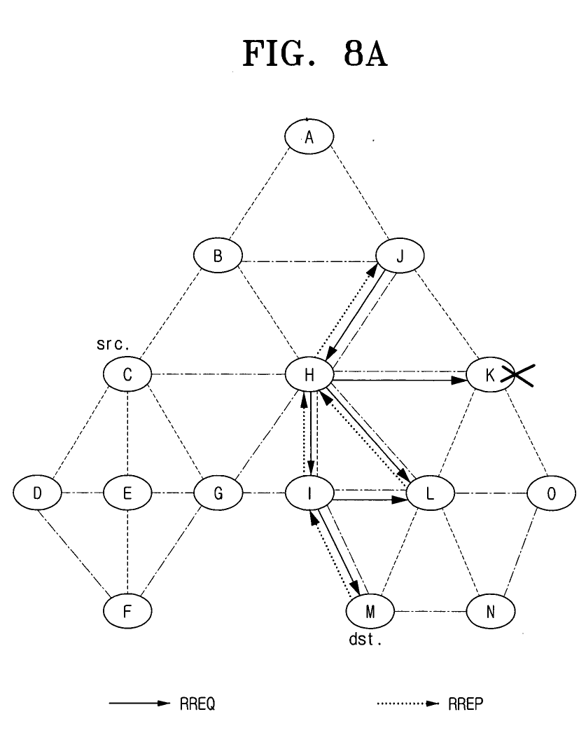

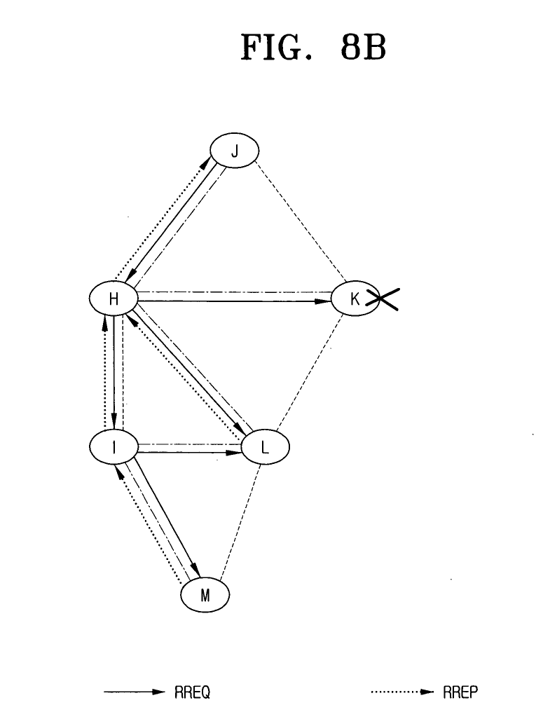

Referring to FIG. 7B, for example, when a packet is transmitted from source node F to destination node I, source node F determines if an optimal or auxiliary route to destination node I is recorded in its ARTT and NTT. In the example shown in FIG. 8B, it is determined that an optimal or auxiliary route to destination node I is not recorded in the ARTT and NTT of source node F. Source node F unicasts an RREQ to destination node I.

Meanwhile, destination node I which received the RREQ knows an optimal route to source node F. That is, an optimal route to source node F is recorded in the NTT of destination node I. Accordingly, destination node I transmits an RREP through the optimal route to source node F. The routing route to transmit the RREP is I-G-F. Destination node I provides information on the optimal route from destination node I to source node F to source node F. Accordingly, a source node can know an optimal route to a destination node, and the source node can transmit a packet through the optimal route to the destination node.

That is, if an optimal route to each node is recorded in the NTT or ARTT of the source node or destination node, the destination node provides information on the optimal route to the source node without performing route discovery again, so that the packet can be transmitted through the optimal route.

FIGS. 8A and 8B are views describing a recovery process when connection between nodes is broken in the wireless network according to an exemplary embodiment of the present invention.

Referring to FIG. 8A, for example, if node K is broken and source node C transmits a packet to destination node M, source node C first transmits the packet to destination node M along the route C-B-J-K-L-M. However, as node K is broken and a connection between node J and node K is broken, destination node M can not receive the packet transmitted from source node C.

Node J detects that node K is broken, and broadcasts an RREQ to its lower nodes. As node J receives an RREP from its lower nodes, connection between node J and lower nodes of node K is recovered. If node J first receives the RREP from one of node I and node L which are upper nodes of destination node M, connection to destination node M is recovered.

That is, if node J first receives the RREP from node L of upper nodes I and L of destination node M, node J recovers connection to node L and destination node M. Node L changes and records its parent node from node K to node H in the tree. That is, the parent node of node L becomes newly-connected node H instead of broken node K.

In addition, if node J receives the RREP from its lower nodes, node J selects as a routing route the node closest to node K among nodes which has transmitted the RREP, and can recover connection to destination node M. That is, if node J receives the RREP from nodes I and L, node J selects as a routing route node L closer to node K, and can recover connection to destination node M.

Meanwhile, referring to FIG. 8B, when node J detects that node K is broken, node J receives the RREP only from lower nodes of node K, so that connection to destination node M can be recovered. That is, node J receives the RREP only from node L, a lower node of node K, instead of all the lower nodes of node J, so that connection to destination node M and lower nodes of node K can be recovered.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A routing method in a tree-based wireless network comprising:
acquiring an optimal route using a table comprising recorded information on neighbor nodes and on lower nodes of the neighbor nodes; and
transmitting a packet through the optimal route.

2. The method of claim 1, wherein in the acquiring the optimal route, the table is searched to acquire the optimal route.

3. The method of claim 2, wherein in the acquiring the optimal route, if an address of a node to receive the packet matches a beginning address recorded in the table, a route through an address of a next hop corresponding to the beginning address recorded in the table is acquired as the optimal route.

4. The method of claim 2, wherein in the acquiring the optimal route, if an address of a node to transmit the packet matches a beginning address recorded in the table, a route through an address of a next hop corresponding to the beginning address recorded in the table is acquired as the optimal route.

5. The method of claim 1, further comprising acquiring an auxiliary route using the table, and transmitting the packet through the auxiliary route instead of the optimal route.

6. The method of claim 5, wherein in the acquiring the auxiliary route, if an address of a node to receive the packet does not match a beginning address recorded in the table, the auxiliary route is acquired by determining whether the address of the node to receive the packet is between an address which is added with “1” to the beginning address recorded in the table, and a last address corresponding to the beginning address.

7. The method of claim 6, wherein in the acquiring the auxiliary route, if the address of the node to receive the packet is between an address which is added with “1” to the beginning address recorded in the table, and the last address corresponding to the beginning address, a route through a node corresponding to the beginning address recorded in the table, and lower nodes of the node corresponding to the beginning address is acquired as the auxiliary route.

8. The method of claim 5, wherein in the acquiring the auxiliary route, if an address of a node to transmit the packet does not match a beginning address recorded in the table, the auxiliary route is acquired by determining whether the address of the node to transmit the packet is between an address which is added with “1” to the beginning address recorded in the table, and a last address corresponding to the beginning address.

9. The method of claim 8, wherein in the acquiring the auxiliary route, if the address of the node to receive the packet is between an address which is added with “1” to the beginning address recorded in the table, and the last address corresponding to the beginning address, a route through a node corresponding to the beginning address recorded in the table, and lower nodes of the node corresponding to the beginning address is acquired as the auxiliary route.

10. The method of claim 9, further comprising transmitting the acquired auxiliary route to one of the nodes to transmit the packet.

11. The method of claim 1, wherein in acquiring the optimal route, the table comprises topology information on the plurality of nodes.

12. The method of claim 11, wherein the topology information comprises at least one of a beginning address of the node, an ending address of the node, a next hop via which the node can be routed, hops to the beginning address of the node, costs to the beginning address of the node, and time when the node is created or refreshed.

13. A communication device operable to determine an optimal path in a tree-based wireless network, the communication device comprising:
a processor that acquires an optimal route using a table comprising recorded information on neighbor nodes and on lower nodes of the neighbor nodes; and
a transmitter that transmits a packet through the optimal route.

14. The communication device of claim 13, wherein the table is searched to determine the optimal route.

15. The communication device of claim 14, wherein in the acquiring the optimal route, if an address of a node to receive the packet matches a beginning address recorded in the table, a route through an address of a next hop corresponding to the beginning address recorded in the table is acquired as the optimal route.

16. The communication device of claim 14, wherein in the acquiring the optimal route, if an address of a node to transmit the packet matches a beginning address recorded in the table, a route through an address of a next hop corresponding to the beginning address recorded in the table is acquired as the optimal route.

17. The communication device of claim 13, wherein the processor acquires an auxiliary route using the table, and the transmitter transmits the packet through the auxiliary route instead of the optimal route.

18. The communication device of claim 17, wherein in the acquiring the auxiliary route, if an address of a node to receive the packet does not match a beginning address recorded in the table, the auxiliary route is acquired by determining whether the address of the node to receive the packet is between an address which is added with “1” to the beginning address recorded in the table, and a last address corresponding to the beginning address.

19. The communication device of claim 18, wherein in the acquiring the auxiliary route, if the address of the node to receive the packet is between an address which is added with “1” to the beginning address recorded in the table, and the last address corresponding to the beginning address, a route through a node corresponding to the beginning address recorded in the table, and lower nodes of the node corresponding to the beginning address is acquired as the auxiliary route.

20. The communication device of claim 17, wherein in the acquiring the auxiliary route, if an address of a node to transmit the packet does not match a beginning address recorded in the table, the auxiliary route is acquired by determining whether the address of the node to transmit the packet is between an address which is added with “1” to the beginning address recorded in the table, and a last address corresponding to the beginning address.

21. The communication device of claim 20, wherein in the acquiring the auxiliary route, if the address of the node to receive the packet is between an address which is added with “1” to the beginning address recorded in the table, and the last address corresponding to the beginning address, a route through a node corresponding to the beginning address recorded in the table, and lower nodes of the node corresponding to the beginning address is acquired as the auxiliary route.

22. The communication device of claim 21, wherein the transmitter transmits the acquired auxiliary route to one of the nodes to transmit the packet.
